(19) United States
(12) Patent Application Publication
(10) Pub. No.: US 2001/0012714 A1
(43) Pub. Date: Aug. 9, 2001

(54) Electrical plug-in connector having at least one locking element

(76) Inventors: Stefan Fenger, Winnenden (DE); Michael Schoenfeld, Leinfelden-Echterdingen (DE); Hannes Kahlhammer, Remseck (DE)

Correspondence Address: KENYON & KENYON, ONE BROADWAY, NEW YORK, NY, 10004, US

(21) Appl. No.: 09/740,170

(22) Filed: Dec. 18, 2000

(30) Foreign Application Priority Data
Dec. 18, 1999 (DE) 299 22 261.6

(51) Int. Cl. H01R 13/627

(52) U.S. Cl. 439/352; 439/357

(57) ABSTRACT

An electrical plug-in connector includes a plug part and a socket part providing an electrical connection for a cable having a plurality of core leads. The plug-in connector includes a locking element. The locking element includes a locking clamp arranged on the plug part. The locking part cooperates with a locking element that is arranged on the socket part. In the plugged-in state of the plug-in connector, the locking clamp cooperates with a locking element that is arranged on the socket part. The socket part includes a protective housing which, in the plugged-in state, surrounds the locking clamp in a U-shaped fashion so that the locking clamp is arranged within the protective housing.

### FIELD OF THE INVENTION

The present invention relates to an electrical plug-in connector having at least one locking element, composed of a plug part and a socket part for producing an electrical connection of a cable composed of a plurality of core leads. The locking element includes a locking clamp arranged on the plug part. The locking clamp, in the plugged-in state of the connector, cooperates with a latching element that is arranged on the socket part.

### BACKGROUND INFORMATION

Electrical connectors are available in a variety of designs.

For example, German Patent 39 32 709 describes an electrical plug-in connector in which the plug part includes a locking clamp that is mounted on the plug itself and is connected to the plug, the locking clamp being configured in a clip shape having its free end in the insertion direction. In the plugged-in state, the locking clamp having the locking element engages in a latch that hinges on the plug part, so that the electrical plug-in connector in the plugged-in state is secured against a predefined tensile force that can potentially act upon the plug part.

Clip-shaped locking clamps of this type are available for network cables, especially for Ethernet connections.

In particular, the designs of the conventional locking clamps have the disadvantage that in the plugged-in state, they are susceptible to interference because, especially in response to forces that do not act directly in the insertion direction and influence the locking clamp, the hinge of the locking clamp on the plug part is destroyed, so that even the function of producing a secured connection between the plug part and the socket part can no longer be assured.

The clip-shaped locking clamps have the advantage that slight actuating forces can be applied as a result of the large locking-clip lengths that are subject to bending. However, they also have the disadvantage that the strength of the locking clamp and therefore the degree of force-locking in the plug-in connection to be generated are negatively influenced by temperature (creeping) and tensile forces (the forceful pulling out of the plug part from the socket part without actuation of the locking clamp).

### SUMMARY

An object of the present invention is to provide an electrical plug-in connector having a plug part and a socket part such that, especially in the plugged-in state, the locking clamp of a locking element continues to perform its function although transverse forces such as tensile and pressure forces are applied on the plug part, the socket part, or even on the locking clamp itself.

To achieve the objective, the locking clamp is protected against damage by using a protective device that virtually completely surrounds the locking clamp. In addition, limit-stop elements are provided which dissipate from the locking connection itself the forces that arise.

The objective is achieved in that the socket part includes a protective housing, which in a virtual U-shape surrounds the locking clamp in the plugged-in state, so that the locking clamp is arranged within the protective housing.

One advantage of the present invention lies in the fact that the locking clamp of the locking element is protected against damage. This is achieved as a result of the fact that protective walls are provided that are advantageously configured as integrated in the socket part and which, in the plugged-in state of the plug-in connector, surround the locking clamp in a U-shape. The opening of this U-shaped configuration is provided in the insertion direction, so that, during the process of plugging in the plug part into the socket part, the locking clamp can be inserted into the U-shaped configuration.

A further advantageous embodiment of the present invention lies in the fact that design elements are provided which protect the locking clamp especially in response to attempts to forcefully pull the plug part out of the socket part without actuating the locking clamp. In addition, design elements are provided that dissipate, away from the locking clamp, the bending stresses of the locking clamp, especially regarding forces that act in the insertion direction, therefore preventing the destruction of the locking clamp and thus of the entire locking connection.

### BRIEF DESCRIPTION OF THE DRAWINGS

FIG. 1 depicts a perspective view of one exemplary embodiment of the electrical plug-in connector in the plugged-in state.

FIG. 2 depicts a view of the socket part, partially including the plug part, along a sectional plane II according to FIG. 1.

FIG. 3 depicts a side view of the electrical plug-in connector according to FIG. 1.

### DETAILED DESCRIPTION

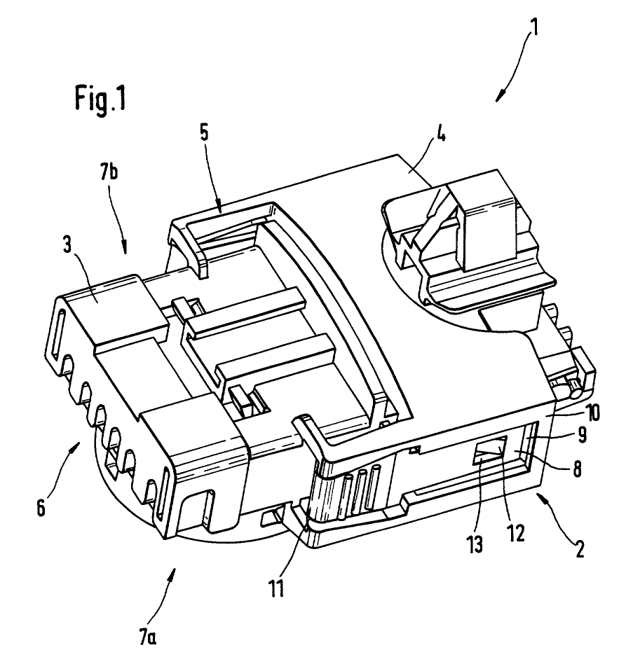

Electrical plug-in connector 1, depicted in FIG. 1, having a locking element 2, is composed of a plug part 3 and a socket part 4. The socket part 4 is provided with an opening 5, in which plug part 3 can be inserted in insertion direction 6. At the free ends of plug part 3, or of socket part 4, electrical connections are arranged that are composed of a plurality of core leads, which nevertheless for reasons of simplicity are not depicted here in this drawing.

Plug part 3 itself has on each longitudinal side 7a and 7b a locking clamp 8 as a part of locking element 2. This locking clamp 8 is arranged in a clip shape on respective longitudinal sides 7a and 7b of plug part 3, the latter's free end 9 pointing in insertion direction 6. During the plug-in procedure in the direction of arrow 6, plug part 3 slides into opening 5 of socket part 4, and at the same time clip-shaped locking element 8 slides into U-shaped protective housing 10 at the side of socket part 4, opening 11 of U-shaped protective housing 10 also being arranged in the insertion direction, so that locking clamp 8 can penetrate without hindrance into protective housing 10 during the plug-in procedure.

For terminating the plug-in procedure, locking clamp 8 of locking element 2 latches onto a latch 12 provided on socket part 4, such that a recess 13, which is provided on the free end of locking clamp 8, covers latch 12. The latching of socket part 4 and plug part 3 is usually produced in this manner. Locking clamp 8 itself is virtually completely surrounded by the U-shaped configuration of protective housing 10, which is configured in this exemplary embodiment so as to be integrally constructed in socket part 4, so that no direct transverse forces can act upon locking clamp 8 which could possibly loosen or eliminate the latched state that is created in this manner.

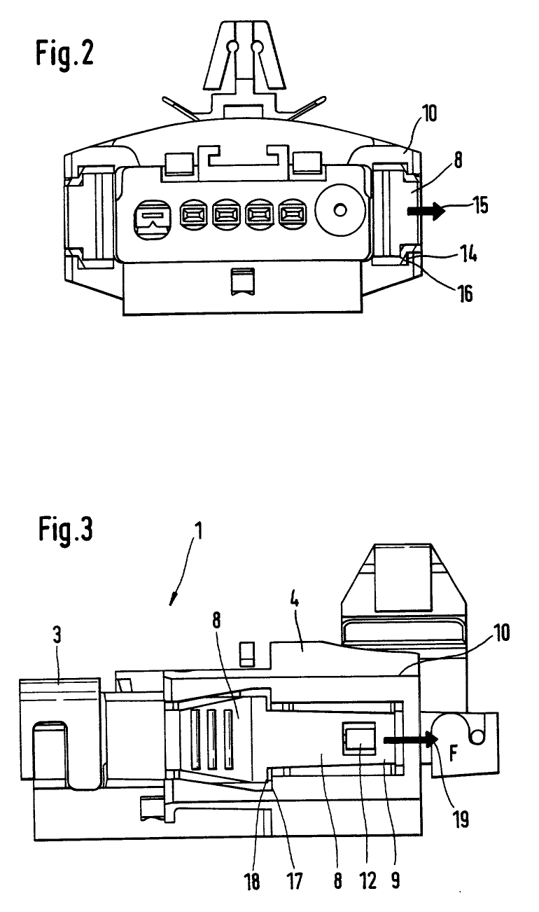

In addition, in this exemplary embodiment, as can be seen from FIG. 2, a limit-stop surface 14 is provided in protective housing 10, the limit-stop surface extending parallel to the extension of locking clamp 8 in the shape of a guide bar. In the plugged-in state, there is play between limit-stop surface 14 and locking clamp 8, so that tilting is avoided during the procedure of plugging in plug part 3 into socket part 4.

If forces act, for example, transverse to the longitudinal extension of plug-in connector 1, as is depicted by an arrow 15 in FIG. 2, then a surface 16 of locking clamp 8 comes into contact with limit-stop surface 14. The result is that transverse forces are dissipated directly onto protective housing 10, so that the total transverse force is prevented from acting directly upon locking clamp 8, thus possibly destroying it.

For the same reasons, a further limit-stop surface 17 is provided, as is depicted in FIG. 3. This limit-stop surface 17 is configured so as to be transverse to the longitudinal extension of plug-in connector 1. This limit-stop surface 17 comes into contact with a further surface 18, which is also arranged so as to be transverse with respect to the longitudinal extension of locking clamp 8, when longitudinal forces such as are depicted in FIG. 3 by arrow 19 are operating. In this manner, free end 9 of locking clamp 8 is prevented from being supported directly on protective housing 10 in a way that would permit the clip-shaped configuration of locking element 8 to be lifted out of latch 12, thus unintentionally releasing the locking connection. It is also possible as a result of this solution that the longitudinal forces in operation here are dissipated away from locking clamp 8 via protective housing 10.

On the basis of these aforementioned multi-step limit-stop surfaces, the locking connection that is effected by locking element 2 is very reliable and is accordingly more stable due to the configuration of corresponding protective housing 10. As a result, temperature fluctuations can be compensated for without influencing the locking connection. In addition, especially in the plugged-in state of electrical plug-in connector 1, damage to locking clamp 8 and therefore locking element 2 is avoided. At the same time, all of the advantages of the clip-shaped configuration of locking clamp 8, or of locking element 2, remain.

What is claimed is:

1. An electrical plug-in connector, comprising:
a plug part;
a socket part, the plug part and the socket part configured to provide an electrical connection for a cable composed of a plurality of core conductors, the socket part including a protective housing; and
a first locking element arranged on the plug part, the first locking element including a locking clamp configured to cooperate with a second locking element arranged on the socket part when the plug-in connector is in a plugged-in state, the protective housing of the socket part surrounding the locking clamp in a U-shaped fashion so that the locking clamp is arranged within the protective housing.

2. The plug-in connector according to claim 1, wherein the protective housing and the socket part are configured as one piece.

3. The plug-in connector according to claim 1, further comprising:
a first limit-stop surface provided in the protective housing, the first limit-stop surface being configured parallel to a longitudinal extension of the locking clamp and configured to be brought into contact with a first surface configured parallel to the longitudinal extension of the locking clamp in response to forces traverse to an insertion direction acting on the plug-in connector.

4. The plug-in connector according to claim 3, further comprising:
a second limit-stop surface provided in the protective housing, the second limit-stop surface configured transverse to the longitudinal extension of the locking clamp and configured to be brought into contact with a second surface configured transverse to the longitudinal extension of the locking clamp in response to longitudinal forces acting on the plug-in connector.
